(19) United States
(12) Patent Application Publication
(10) Pub. No.: US 2005/0063770 A1
(43) Pub. Date: Mar. 24, 2005

(54) Gate bracket

(76) Inventor: John Gross, Vancouver (CA)

Correspondence Address: Paul Smith Intellectual Property Law, 330-1508 West Broadway, Vancouver, BC, V6JIW8, CA

(21) Appl. No.: 10/980,251

(22) Filed: Nov. 4, 2004

Related U.S. Application Data
(63) Continuation of application No. 10/265,226, filed on Oct. 7, 2002.

(51) Int. Cl. F16B 1/00

(52) U.S. Cl. 403/205

(57) ABSTRACT

A connector for use in rigidly joining two adjacent structural members at a joint. The connector has a first, second and third elongated flat members. The second member extends from a first end of the first member and is perpendicular thereto. The third member extends from the first member in spaced parallel relationship with the second member. An angular cross brace extends between the first and third members. A hinge may be connected to the second member.

### CROSS-REFERENCE TO RELATED APPLICATION

This application is a continuation of U.S. application Ser. No. 10/265,226 filed Oct. 7, 2002, entitled GATE BRACKET.

### FIELD OF THE INVENTION

The invention relates to the field of structural bracing and in particular gate brackets for use in building a door for a gate.

### BACKGROUND OF THE INVENTION

When building a structure such as a gate door, different structural members are brought together and fastened into position at joints. This has led to the proliferation of many different designs and constructions of structural joints. Whether the joint is constructed using temporary measures such as screws or a more permanent one such as welding or gluing, the end result is the connection of two structural elements at a joint.

Depending on the type of joint, different limitations prevail. These include lack of strength and difficulty of construction. For the most part, temporary joints tend to be weaker than the permanent ones, but are easier to make.

This has led to the development of hardware brackets for joining and retaining wood pieces or other structural members at joints. For example, U.S. Design Pat. No. 410,835 discloses a set of two U-shaped elements that are welded together such that they are perpendicular to one another. A hinge is welded across the joint between the two U-shaped elements. While the gate bracket taught in the '835 design patent is easy to use and provides rigidity to the joints, it suffers from several drawbacks. Locating the hinge across the joint between the elements requires careful welding first of the elements in order to ensure a flat surface upon which to attach the hinge, and of the hinge itself. In addition, because each element comprises a three-sided bracket within which to place a wood piece, a substantial amount of metal is used in this design.

Canadian Industrial Design No. 83050 discloses first and second straight elongated flat rectangular members at right angles to one another. A rectangular hinge is attached at right angles to the end of a short extension of the first member. An additional cross-brace member extending between the rectangular members provides additional support. But because the hinge is connected edge-wise to the end of one of the rectangular members, its connection is a weak one and of limited strength. The hinge requires very careful welding in order to ensure that it is attached perpendicular to the brace member and may be damaged should it inadvertently come into contact with another object. In addition, apart from the weld, the hinge is supported only by direct connection with the lumber used to frame the gate.

Accordingly, a need exists for an improved joint bracket construction providing ease in construction and high strength and which overcomes the defects noted above.

### SUMMARY OF THE INVENTION

According to the present invention there is provided a connector or gate bracket for rigidly joining two adjacent structural members at a joint comprising a flat elongated first member having a first and a second ends, a flat elongated second member extending in one direction from, and perpendicular to, the first member, from the first end of the first member, a flat elongated third member extending from the first member in spaced parallel relationship with the second member, and an angular cross brace extending between the first and the third members.

In another aspect, the cross brace defines a 45 degree angle in relation to the first member and in relation to the third member.

In yet another aspect of the invention, the connector further comprises a hinge secured to the second member in face to face relationship. The hinge may be secured to the second member by welding.

In yet another aspect of the invention, the cross brace is secured to the first member between the second end of the first member and the third member and is secured to the third member between a free end of the third member and the first member.

In yet a further aspect, a plurality of holes are located in each of the first, second and third members.

In yet another aspect, the second and third members are the same length.

In yet another aspect, the first member is longer than the second and third members.

In yet another aspect, the second member is spaced from the third member a distance equal to a standard width of cut lumber.

Other aspects of the invention will be appreciated by reference to the detailed description of the preferred embodiment and to the claims that follow.

### BRIEF DESCRIPTION OF THE DRAWINGS

These and other features of the invention will become more apparent from the following description in which reference is made to the appended drawings and wherein:

FIG. 1 is a perspective view of a set of gate brackets according to the invention, the structural gate boards being shown in stippled lines;

FIG. 2 is a perspective view of the gate bracket shown in the lower right position in FIG. 1, the gate bracket shown in the upper right position in FIG. 1 being identical thereto; and

FIG. 3 is a perspective view of the gate bracket shown in the lower left position in FIG. 1, the gate bracket shown in the upper left position in FIG. 1 being the mirror image thereof.

### DESCRIPTION OF THE PREFERRED EMBODIMENT OF THE INVENTION

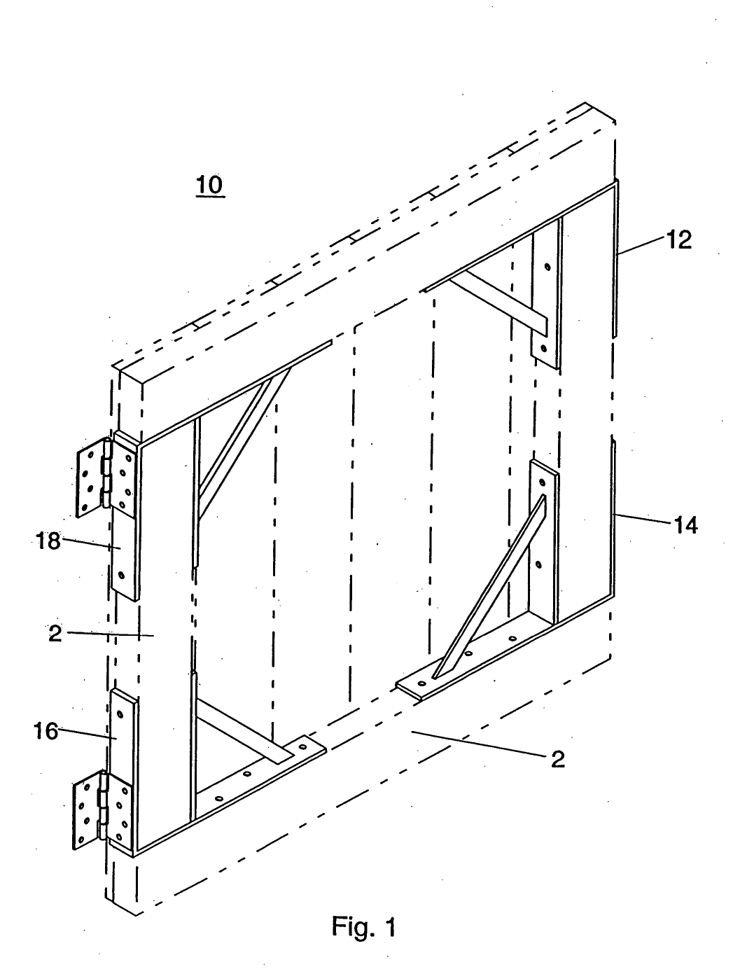

The preferred embodiment of a set of gate brackets 10 is illustrated in FIG. 1.

A set of four connectors such as gate brackets 12, 14, 16, 18 may be used to join structural elements, such as lumber pieces 2 shown in phantom, so as to form a frame for a door or the like. Bracket 12 is a mirror image of bracket 14, while bracket 18 is a mirror image of bracket 16.

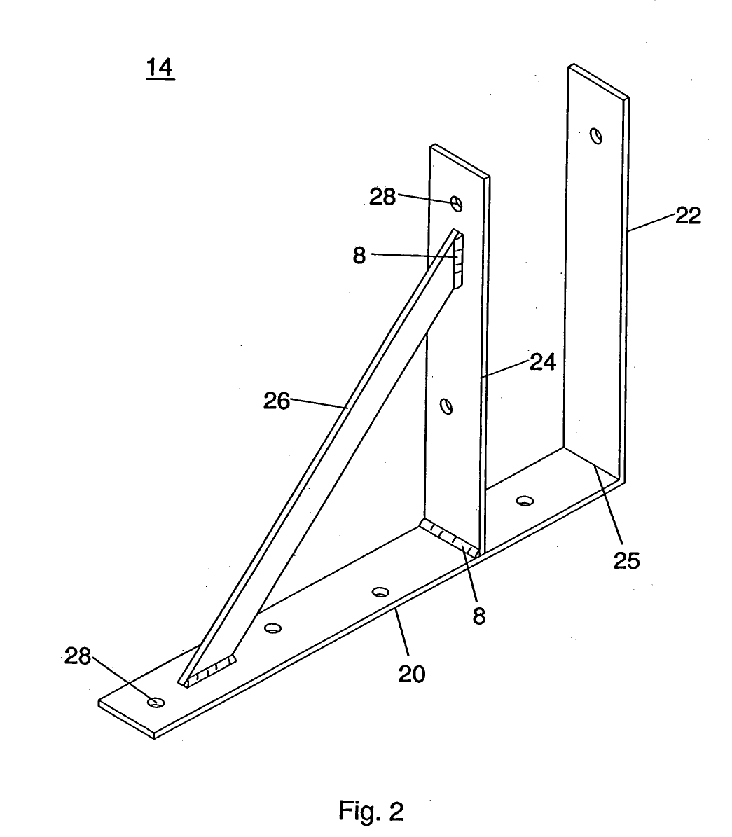

As shown in FIG. 2, bracket 14 has a flat elongated first member 20 and a flat elongated second member 22 extending perpendicular thereto. First member 20 and second member 22 are preferably made of a single flat strip of metal, bent at 25 to define perpendicular members 20, 22. A flat elongated third member 24 is secured to first member 20 in spaced parallel relationship to second member 22, such that third member 24 is also perpendicular to first member 20. Preferably third member 24 is secured to first member 20 by welding as at 8. An angled brace 26 extends between third member 24 and first member 20 on the side of member 24 that is distal from second member 22. The angled brace 26 provides structural reinforcing to the bracket 14. Holes 28 are present in the bracket for connecting the bracket to lumber or wood pieces 2. The size of the members 20, 22 and 24 and the spacing between members 22 and 24 may be varied in order to accommodate different sizes of lumber. The spacing between members 22 and 24 is chosen to correspond to standard widths of cut lumber, for example 3 and 1/2 inches to accommodate 2×4 lumber.

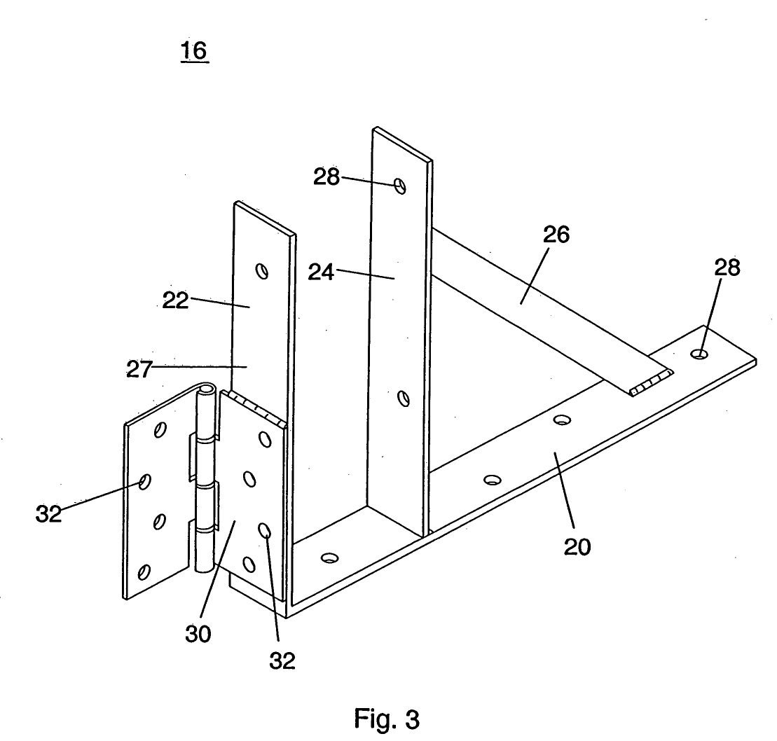

FIG. 3 shows the lower left bracket 16. Components identical to those of the bracket 14 have been identified with identical reference numbers. Additionally, a hinge 32 is welded in face to face relationship to the exterior surface 27 of the member 22. Hinge 30 also has holes 32 for connecting to lumber or other structural elements. Holes 32 also pass through second member 22.

A method of using the brackets 12, 14, 16, 18 in association with 2×4 lumber to build a gate door will now be described. Top and bottom 2×4's are cut one inch shorter than the width of the proposed gate opening. Elongated first members 20 are attached to the 2×4's with suitable fasteners, preferably screws, inserted through holes 28. The top and bottom 2×4's are positioned so that second members 22 extend past the ends of the respective 2×4's as shown in FIG. 1.

Left and right 2×4's are cut to an appropriate length to define the height of the gate door. The left and right 2×4's are positioned within the spaces between second and third members of the respective brackets. The space between the second and third members 22, 24 is selected to snugly accommodate the lumber 2. Once again, suitable fasteners are inserted through holes 28 and 32 in order to attach the left and right 2×4's to the brackets: Further lumber may then be connected to the top, bottom, left and right 2×4's to complete the gate door. Hinges 30 are attached, preferably by screws to a structural member of a fence in order to connect the gate door to the fence.

It will be appreciated by those skilled in the art that the preferred and alternative embodiments have been described in some detail but that certain modifications may be practiced without departing from the principles of the invention.

1. A connector for rigidly joining two adjacent structural members at a joint comprising:
a flat elongated first member having a first and a second ends and a first and a second flat sides;
a flat elongated second member extending in one direction from, and perpendicular to, said first flat side of said first member from said first end, said second member terminating in a free end;
a flat elongated third member extending from said first flat side of said first member in between said first and second ends of said first member and in spaced parallel relationship with said second member, said third member terminating in a free end;
said second and third members and a portion of said first member extending between said second and third members forming a u-shape; and
an angular cross brace extending between said first and said third members.

2. The connector of claim 1 wherein said cross brace defines a 45 degree angle in relation to said first member and in relation to said third member.

3. The connector of claim 1 further comprising a hinge secured to said second member in face to face relationship.

4. The connector of claim 3 wherein said hinge is secured to said second member by welding.

5. The connector of claim 1 wherein said cross brace is secured to said first member between said second end of said first member and said third member and is secured to said third member between a free end of said third member and said first member.

6. The connector of claim 1 wherein a plurality of holes are located in each of said first, second and third members.

7. The connector of claim 1 wherein said second and third members are the same length.

8. The connector of claim 7 wherein said first member is longer than said second and third members.

9. The connector of claim 1 wherein said second member is spaced from said third member a distance equal to a standard width of cut lumber.

10. A connector for rigidly joining two adjacent structural members at a joint comprising:
an elongated first member extending from a first free end on a first portion to a second free end on a second portion, said first portion being perpendicular to said second portion;
a flat elongated second member extending from said first portion of said first member in spaced parallel relationship with said second portion of said first member, said second member terminating in a free end; and
an angular cross brace extending between said first portion of said first member and said second member.

11. The connector of claim 10 wherein said cross brace defines a 45 degree angle in relation to said first portion of said first member and in relation to said second member.

12. The connector of claim 10 further comprising a hinge secured to said second portion of said first member in face to face relationship.

13. The connector of claim 12 wherein said hinge is secured to said second member by welding.

14. The connector of claim 10 wherein said cross brace is secured to said first portion of said first member between said first free end of said first member and said second member and is secured to said second member between said free end of said second member and said first portion of said first member.

15. The connector of claim 10 wherein a plurality of holes are located in each of said first and second members.

16. The connector of claim 10 wherein said second portion of said first member and said second member are the same length.

17. The connector of claim 16 wherein said first portion of said first member is longer than said second portion of said first member and said second member.

18. The connector of claim 10 wherein said second portion of said first member is spaced from said second member a distance equal to a standard width of cut lumber.

19. A connector for rigidly joining two adjacent structural members at a joint comprising:
a flat elongated first member having a first and a second ends and a first and a second flat sides;
a flat elongated second member extending in one direction from, and perpendicular to, said first flat side of said first member from said first end, said second member terminating in a free end, said first and second member forming a single L-shaped member extending from said second end of said first member to said free end of said second member;
a flat elongated third member extending from said first flat side of said first member in between said first and second ends of said first member and in spaced parallel relationship with said second member, said third member terminating in a free end; and
an angular cross brace extending between said first and said third members.

20. The connector of claim 19 wherein said second and third members and a portion of said first member extending therebetween forming a u-shape.
